(19) United States
(12) Patent Application Publication
(10) Pub. No.: US 2016/0063649 A1
(43) Pub. Date: Mar. 3, 2016

(54) FAVOR DETECTION AND REPAYMENT SYSTEM

(71) Applicant: EBAY INC., San Jose, CA (US)

(72) Inventor: Kamal Zamer, San Jose, CA (US)

(21) Appl. No.: 14/473,411

(22) Filed: Aug. 29, 2014

(51) Int. Cl. G06Q 50/00; G06Q 20/10

(52) U.S. Cl. CPC G06Q 50/01; G06Q 20/10

(57) ABSTRACT

Systems and methods for favor detection and repayment include storing an ownership association between a first user and a first user item. A second user is detected making a purchase that is associated with the first user item. The purchase by the second user that is associated with the first user item is detected as being a favor for the first user by the second user. Favor repayment information is then retrieved. A favor detection message is provided for display to the first user, and at least one favor repayment option is provided for display to the first user using the favor repayment information.

### BACKGROUND

1. Field of the Disclosure

The present disclosure generally relates to online and/or mobile payments and more particularly to a favor detection and repayment system that may be used with online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

In some situations, online and/or mobile payments may be used for purchases that are made as favors for other users. For example, a first user may have an item such as a car, and a second user may borrow that car and make a purchase of gas for the car. In another example, the second user may purchase groceries for the first user. In yet another example, the second user may make a purchase of services to fix an item owned by the first user. In each of these situations, the first user may be unaware of the favor performed by the second user and, even if informed of the favor, the first user may not know how to repay the second user for the favor. Conventionally, a first user that receives a favor from the second user must be informed of that favor by the second user or must notice that the favor was performed themselves, and then must determine how to properly return the favor, which can be difficult and time-consuming for the first user.

Thus, there is a need for an improved favor detection and repayment system.

### BRIEF DESCRIPTION OF THE FIGURES

FIG. 1 is a flow chart illustrating an embodiment of a method for favor detection and repayment;

FIG. 2 is a schematic view illustrating an embodiment of a favor detection and repayment system;

FIG. 3a is a screen shot illustrating an embodiment of a user device displaying an item ownership screen;

FIG. 3b is a screen shot illustrating an embodiment of a user device displaying favor reporting screen;

FIG. 4 is a screen shot illustrating an embodiment of a user device displaying a favor detection screen;

FIG. 5a is a screen shot illustrating an embodiment of a user device displaying a favor repayment screen;

FIG. 5b is a screen shot illustrating an embodiment of a user device displaying a favor information reporting screen;

FIG. 6 is a schematic view illustrating an embodiment of a networked system;

FIG. 7 is a perspective view illustrating an embodiment of a user device;

FIG. 8 is a schematic view illustrating an embodiment of a computer system; and

FIG. 9 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for detecting and repaying favors by first determining that a user (referred to herein as a “first user”) is an owner of an item or is the beneficiary of a purchase. For example, the first user may be determined to be the owner of an item by designating themselves as the owner of the item, purchasing the item, making one or more purchases for the item, or being regularly co-located with the item. The system and method may then determine that a non-owner user (referred to herein as a “second user”) has performed a favor for the second user by making a purchase associated with that item or for the benefit of the first user. For example, the second user may purchase gas for a car of the first user, may pay to repair a bicycle of the second user, may purchase groceries for the first user, or may make a purchase for a child of the first user. The systems and methods then operate to determine a favor level of the purchase made by the second user by determining current situations of the first and second users that may analyze financial situations of the first and second users, schedules of the first and second users, locations of the first and second users, and/or other factors that may be interpreted in order to rank the favor performed by the second user in making the purchase. Favor repayment information may then be retrieved to determine possible favor repayment options that may include items that the first user may purchase for the second user to return the favor. The first user may then be informed that the favor was performed by the second user, and provided the favor repayment options to select items for repaying the favor to the second user. Thus, the systems and methods notify a first user when second users perform favors for them, and may classify the favor to suggest appropriate options for favor repayment based on that classification.

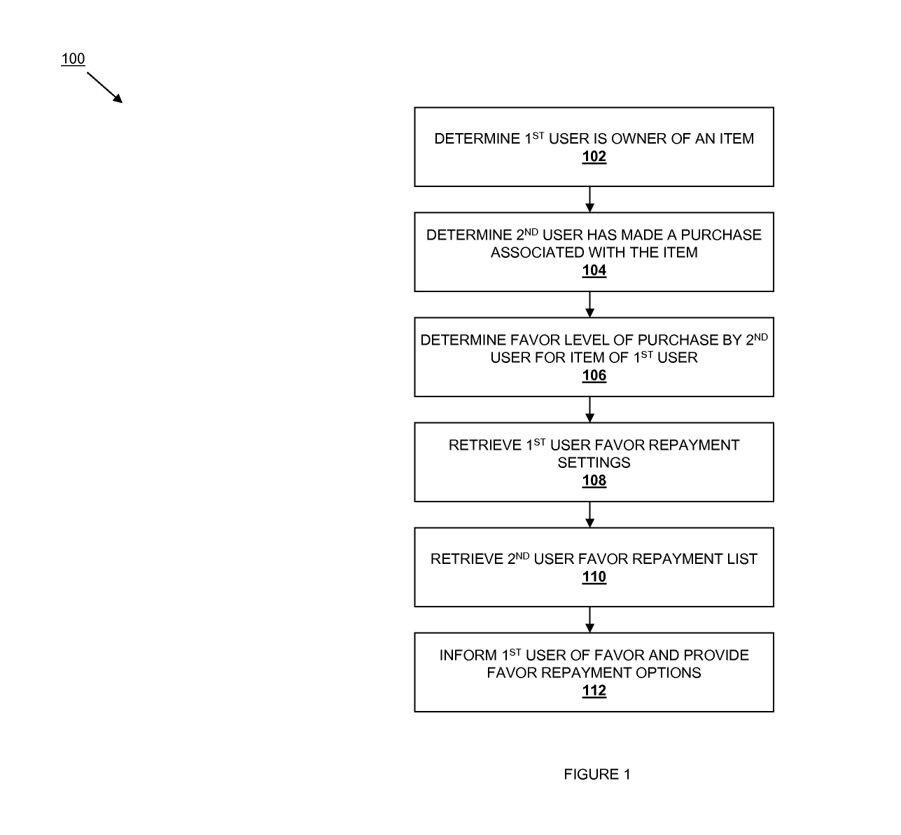

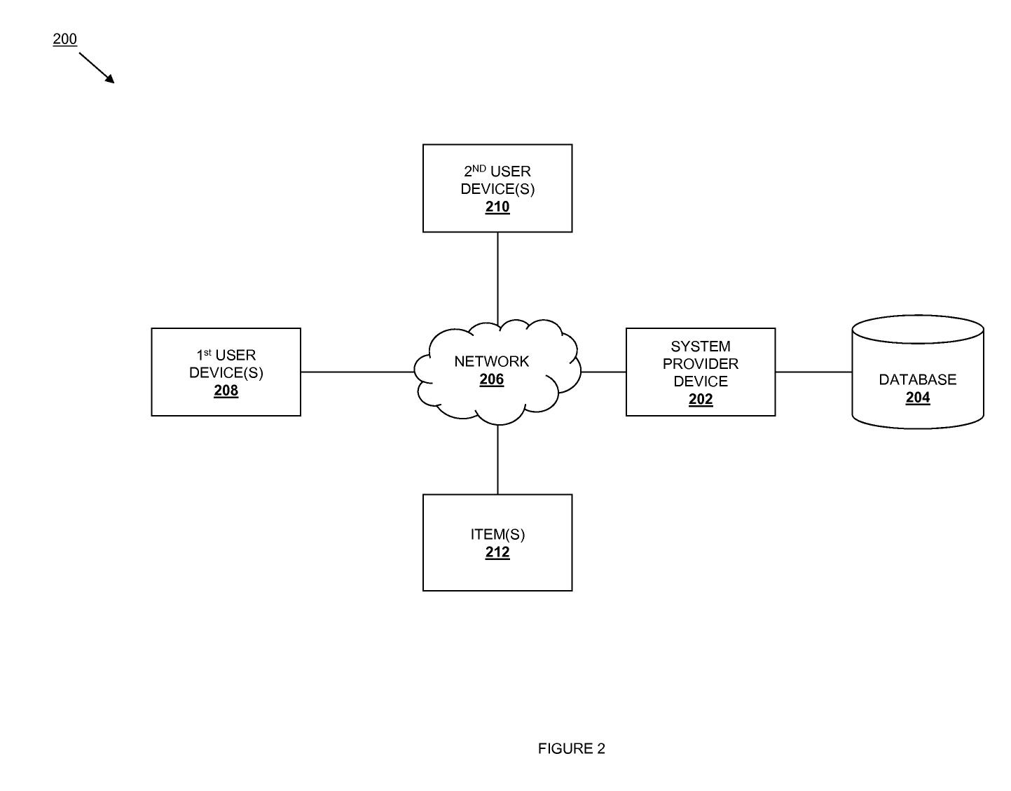

Referring now to FIGS. 1 and 2, an embodiment of a method 100 for detecting and repaying favors and an embodiment of a favor detection and repayment system 200 for performing the method 100 are illustrated. The favor detection and repayment system 200 includes a system provider device 202 that is coupled to a database 204 and a network 206. In the embodiments discussed below, the system provider device 202 may be operated by a payment service provider such as, for example, PayPal Inc. of San Jose, Calif., that provides payment services for users and merchants by providing payment service accounts that may be funded using funding accounts provided by funding account providers (e.g., bank account providers, credit account providers, the payment service provider, etc.). As such, the payment service provider may operate a payment service provider device/system provider device 202 to facilitate transactions between users (via their user payment service accounts) and merchants (via their merchant payment service accounts) by transferring funds between their associated accounts for purchases. However, other account providers, third party providers, and/or other system providers known in the art may operate the system provider device 202 while remaining within the scope of the present disclosure. While the database 204 is illustrated as a single database that is directly coupled to the system provider device 202, the database 204 may be part of one or more combined databases (e.g., it may be one of a plurality of databases provided accessible by the system provider device 202 such as, for example, payment databases, user databases, merchant databases, and/or other databases discussed below) and may be coupled to the system provider device 202 through the network 206.

One or more first user devices 208 are coupled through the network 206 to the system provider device 202. In the examples below, the first user devices 208 are illustrated and described as mobile phones, but desktop computers, tablet computers, wearable computers, and/or any other computing system known in the art may be utilized as a user device while remaining within the scope of the present disclosure. One or more second user devices 210 are coupled through the network 206 to the system provider device 202 and may include mobile computers, desktop computers, tablet computers, wearable computers, server computers, and/or any other computing system known in the art. One or more items 212 may, in some embodiments, be coupled through the network 206 to the system provider device 202 and may include mobile computers and/or other computing system known in the art. While a few devices and systems are illustrated in the example of the favor detection and repayment system 200 of FIG. 2, other devices and systems may interact with the system provider device 202 to provide more advanced functionality while remaining within the scope of the present disclosure.

In the embodiments discussed below, the system provider may provide an application and/or website that is executable and/or accessible by the first user devices 208, the second user devices 210, and/or the items 212 to allow for the functionality of the first user devices 208, second user devices 210, and items discussed below (e.g., the provision of the screens, the interactions between the user devices, items, and system provider devices 202, and/or any of the other functionality discussed below). For example, in many of the embodiments discussed below, the system provider is a payment service provider that provides a payment application that operates on the user devices and provides for the exchange of at least some of the information in the method 100. However, other entities may provide applications and/or websites accessed or used by the first user devices 208, the second user devices 210, the items, and the system provider device 202 to enable the functionality described herein while remaining within the scope of the present disclosure.

Referring now to FIGS. 1 and 2, the method 100 begins at block 102 where a first user is determined to be an owner of an item. In an embodiment, the system provider device 202 may communicate with the first user device 208 to determine that a first user associated with the first user device 208 is an owner of an item 212 and, in response, associate the first user with that item in the database 204. A few examples of the determination that the first user is an owner of an item are provided below, but one of skill in the art in possession of the present disclosure will recognize that the determination that a user is an owner of an item may be performed using a wide variety of techniques that will fall within the scope of the present disclosure. Furthermore, while the “ownership” of an item by a first user is described in many embodiments below as the ownership by that first user of a physical object, other associations of the first user and “items” will fall within the scope of the present disclosure.

For example, an item may in some situations include a house occupied by a first user, or areas within that house, such that any purchases made for that house or purchases of items that are used in that house may be determined to be favors within the scope of the method 100. Furthermore, an item may in some situations include a child or dependent of a first user such that any purchases made for that child or items that are used by that child may be determined to be favors within the scope of the method 100. As such, the term “item” may be interpreted as an object, an area or location (e.g., within a home), a person or pet, and/or other things for which the first user is responsible (e.g., typically makes purchases), and the term “ownership” or “owner” may refer to any association between the first user and the “item”.

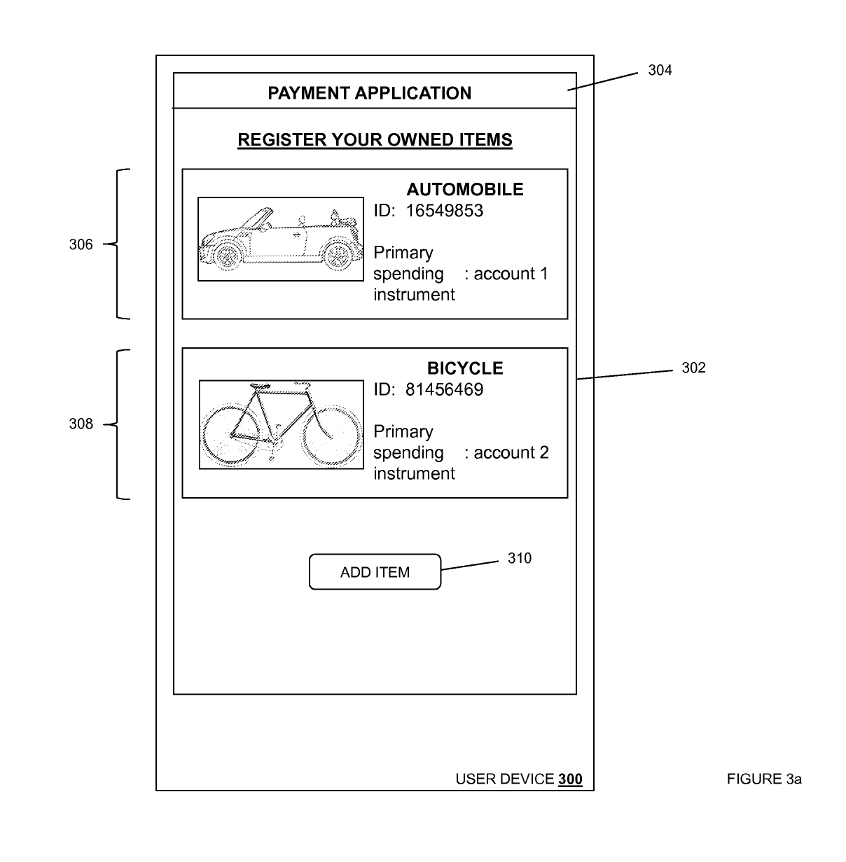

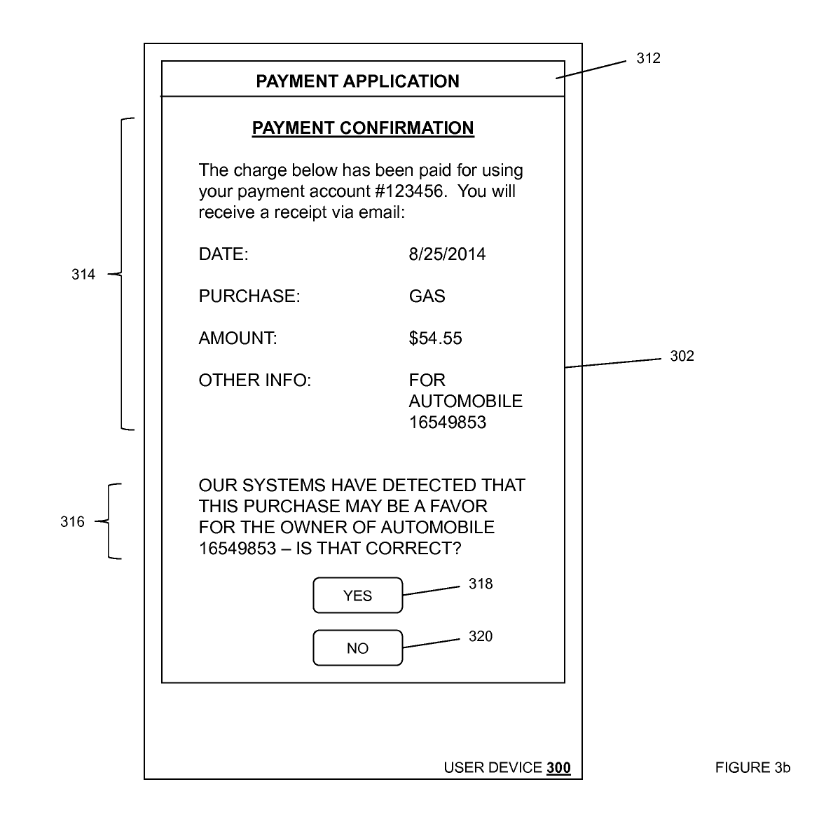

Referring now to FIG. 3a, an embodiment of a user device 300, which may be the first user device 208 discussed above with reference to FIG. 2, is illustrated that includes a display 302 displaying an item ownership screen 304. The item ownership screen 304 includes a first item ownership section 306 and a second item ownership section 308. In the illustrated embodiment, the first item ownership section 306 indicates that the first user of the user device 300 is an owner of an automobile, and includes an image of the automobile, an identification number of the automobile, and a primary spending instrument that is typically used for purchases made for the automobile. In the illustrated embodiment, the second item ownership section 308 indicates that the first user of the user device 300 is an owner of a bicycle, and includes an image of the bicycle, an identification number of the bicycle, and a primary spending instrument that is typically used for purchases made for the bicycle. While a payment application on the user device 300 is illustrated in FIG. 3a as providing the item registration screen 304, the item ownership screen 304 may be provided by other applications or websites (i.e., as part of a website on which an item was purchased) known in the art.

In some embodiments, the item ownership screen 304 is also an item registration screen that allows the first user to designate themselves as an owner of items to the system provider device 202 over the network 206. In such embodiments, the item ownership screen 304 includes an add item button 310 that the user may select to designate themselves the owner of additional items. As such, the user may have previously designated themselves the owner of the automobile in the first item ownership section 306 and the bicycle in the second item ownership section 308 by selecting the add item button 310 and providing any of a variety of information about that item (e.g., the images, the identification numbers, and the primary spending instruments). While specific information about the items is illustrated in FIG. 3a, other information may be provided about those items including, for example, secondary users (e.g., a child or spouse that uses the item), common purchases made for the item (e.g., gas, tires, service), and/or any other information about the item that may be utilized by the system provider device 202 in determining whether a favor has been performed for the first user, discussed in further detail below.

In other embodiments, the first user/item ownership associations may be determined by the system provider device 202, and the item ownership screen 304 may be provided to the first user to review those ownership associations (or provision of the item ownership screen 304 may be omitted from the method 100). For example, as discussed above, the system provider device 202 may be operated by a payment service provider that has access to a payment account or purchase history of the first user that may be stored in the database 204. At block 102, the system provider device 202 may monitor and/or review that payment account or purchase history to determine items that the first user has purchased and, in response, store an ownership association between the first user and those items in the database 204. In some embodiments, the ownership associations between the first user and items that are determined from payment accounts or purchase histories and that are stored in the database 204 may be limited to items for which purchases may be made (e.g., items that need components replaced, items that consume fuel, items that are serviced, etc.). However, in other embodiments, any items purchased by the first user may be associated with the first user.

In another example, the ownership associations between the first user and items in the database 204 may be determined by the system provider device 202 monitoring the payment account or purchase history of the first user and determining that the first user makes purchases for those items. For example, the payment account or purchase history may include purchases for an item that designate that item such as, for example, purchases of automobile services for an automobile, purchases of gas for the automobile, etc., and that such purchases for the item may indicate to the system provider device 202 that the first user is the owner of the item. As such, purchases made for a home (e.g., roof repair, gardening services, rent payments, mortgage payments, etc.) may indicate to the system provider device that the user is the owner of (or is otherwise responsible for) the home, purchases made for a child (e.g., clothing, food, events, etc.) may indicate to the system provider device that the user is responsible for the child, etc.

In another example, the ownership associations between the first user and items in the database 204 may be determined by the system provider device 202 by monitoring the location of the first user via their first user device 208 and the location of the item 212 and determining that the first user is co-located with the item (e.g., a minimum number of times, at a minimum frequency, when a purchase was made for that item, etc.). For example, the item 212 may be a “smart item” that includes a computing system that is connected to the system provider device 202 through the network 206 via a communication system, and the item 212 may include a location determination device that reports the location of the item 212 to the system provider device 202. The system provider device 202 may then receive location information from each of the first user device 208 associated with the first user and the item 212, and may analyze that location information to determine when the first user and the item are co-located. In addition, the system provider device 202 may cross reference any co-location information with a payment account and/or purchase history of the first user to determine if purchases are made by the first user for the item (e.g., gas when the first item is an automobile) when the two are co-located. Based on that co-location (and in some cases the purchases made while being co-located), the ownership association between the first user and the item may be stored in the database 204.

Furthermore, items 212 that are “smart items” may be configured to communicate with the first user device 208 of the first user in order to establish or indicate an ownership association between the first user and the item 212. For example, many automobiles have computing systems that communicate with user mobile phones (e.g., to play music, make phone calls using the sound system of the automobile, etc.) to perform other actions, and that communication may be provided to the system provider device 202 and may allow the system provider device to determine an ownership relationship exists between the first user and the automobile. Similarly, many homes include computing systems that communicate with user mobile phones and may be utilized by the system provider device to determine an ownership relationship exists between the first user and the home. Furthermore, while some conventional items may not currently include “smart” systems that communicate with user mobile phones, such communication systems may be provided in the future on those conventional items to allow for the co-location of a user mobile phone and that conventional item to be determined and/or otherwise indicate an ownership association between the first user and the conventional item.

Thus, a plurality of different techniques may be used to determine that the first user is the owner of an item, and any of the techniques described above may be combined or used to determine ownership associations between the first user and their items, or determine a degree of confidence that a first user is the owner of items. Furthermore, as discussed above, items may include many things other than physical objects purchased by the first user, and the system provider device 202 may determine that the first user is the “owner” of those “items” in a variety of ways. In an embodiment, the first user may be associated with (an “owner” of) an area of a home (an “item”) that the user owns, rents, or otherwise occupies. For example, the system provider device 202 may determine that the first user is associated with an area of a home based on the user's designation, user purchases associated with the home (e.g., a mortgage payment, home ownership insurance payments, rental payments, home improvement payments, etc.), a user being co-located with the home (or co-located with an area of the home such as a particular bedroom), etc. In another embodiment, the first user may be associated with (an “owner” of) a child or other dependent (an “item”) of the user. For example, the system provider device 202 may determine that the first user is associated with a child based on the user's designation, user purchases associated with the child (e.g., clothing purchases, food purchases, etc.), a user being co-located with the child (e.g., via location information received from a user device associated with the child), etc. As such, one of skill in the art will recognize that the first user may be determined by the system provider device 202 to be an owner of an item at block 102 in a variety of manners for a variety of different types of items, just some of which are discussed herein.

The method 100 may then proceed to block 104 where it is determined that a second user has made a purchase associated with the item owned by the first user. In an embodiment, the system provider device 202 may determine that a second user associated with a second user device 210 has made a purchase associated with the item for which the first user was determined to be the owner at block 102. While a few examples are provided below of a second user making a purchase for an item owned by the first user to perform a favor for the first user, one of skill in the art will recognize that a second user may make purchases for items owned by a first user or perform favors for a first user in a variety of ways and for a variety of reasons that will be detectable by the system provider device 202 using the techniques discussed below, and such purchases and/or favors will fall within the scope of the present disclosure.

In an embodiment, the system provider device 202 may detect the purchase by the second user for the item owned by the first user by monitoring a payment account of the second user to determine that a purchase was made by the second user that identifies the item that is owned by the first user. For example, the second user may replace a tire on an automobile that the first user is an owner of, and the purchase information associated with a payment for that service may identify the automobile via an identification number such as a license plate, a VIN, or other automobile identification information known in the art. In another example, the second user may purchase materials for a home that the first user is an owner of, and the purchase information associated with a payment for those materials may identify the home via an identification number such as an address, the first user's identity (as the owner of the home), or other home identification information known in the art. In yet another example, the second user may purchase items or services for a child of the first user, and the purchase information associated with a payment for those items or services may identify the child via identification information such as a social security number, the first user's identity (e.g., as the parent of the child), or other child identification information known in the art.

In an embodiment, the system provider device 202 may detect the purchase by the second user for the first item owned by the first user by determining that the second user was co-located with the item when the purchase was made. As discussed above, the item 212 may be a “smart item” that includes a computing system that is connected to the system provider device 202 through the network 212 through a communication system, and the item may include a location determination device that the item 212 may use to report its location to the system provider device 202. The system provider device 202 may receive location information from each of the second user device 210 associated with the second user and the item 212, and may analyze that location information to determine when the second user and the item 212 are co-located. In addition, the system provider device 202 may cross reference any co-location information with a payment account and/or purchase history of the second user to determine if purchases are made by the second user for the item (e.g., a purchase of gas when the first item is an automobile) when the two are co-located. Based on the co-location of the second user and the item 212 when the purchase was made by the second user, that purchase may be determined to be for the item 212. In such embodiments, the system provider device 202 may also retrieve location information from the first user device 208 of the first user to determine whether the first user was co-located with the item 212 when the purchase was made by the second user, and in some situations that purchase by the second user may be determined to be (or may be determined to more likely be) for the item 212 if the first user was not co-located with the item 212 when the purchase was made by the second user.

Furthermore, items 212 that are “smart items” may be configured to communicate with the second user device 210 of the second user in order to establish or indicate that the second user is co-located with or otherwise using the item 212. As discussed above, many automobiles have computing systems that communicate with user mobile phones (e.g., to play music, make phone calls using the sound system of the automobile, etc.) to perform other actions, and that communication may be provided to the system provider device 202 and may allow the system provider device to determine that the second user is co-located with or otherwise using the automobile owned by the first user. Similarly, many homes include computing systems that communicate with user mobile phones and may be utilized by the system provider device 202 to determine that the second user is co-located with or otherwise using the home owned by the first user. Furthermore, while some conventional items may not currently include “smart” systems that communicate with user mobile phones, such communication systems may be provided in the future on those conventional items to allow for the co-location of a user mobile phone and that conventional item to be determined and/or otherwise indicate that the second user is co-located with or otherwise using the conventional item.

Thus, a plurality of different techniques may be used to determine that the second user has made a purchase associated with an item owned by a first user. Furthermore, as discussed above, items may include many things other than physical objects owned by the first user, and the system provider device 202 may determine that the second user has made a purchase for those “items” in a variety of ways. As discussed above, the “item” may be an area of a home (e.g., a kitchen or pantry) that the first user owns, rents, or otherwise occupies. For example, the system provider device 202 may determine that the second user has purchased groceries for the first user (e.g., for a kitchen or pantry of the home) in response to receiving purchase information about the purchase of the groceries by the second user, along with detecting that the second user immediately followed that purchase with a trip to the home of the first user. In addition, the system provider device 202 may determine that the second user recently brought groceries (i.e., for themselves) and/or detect that the first user does not buy groceries for a period of time following the detected purchase of groceries by the second user to confirm that the groceries purchased by the second user were for the first user. As such, many different sources of information may be retrieved to detect, confirm, or otherwise determine to some degree of certainty that the second user has made the purchase for the item owned by the first user.

In another embodiment, the system provider device 202 may determine that the second user has made a purchase for a child or other dependent of the first user. For example, the system provider device 202 may determine that the second user has made a purchase for a child of the first user based on the two being co-located (e.g., via location information from user devices of the second user and the child) during a purchase associated with a child (e.g., children's clothing, school supplies, a child's meal at a restaurant). Other information that may be retrieved to confirm that the purchase by the second user was for the child of the first user may include information indicating that the second user does not have children. As such, one of skill in the art will recognize that the second user may be determined by the system provider device 202 to have made a purchase for an item owned by the first user at block 104 in a variety of manners for a variety of different types of items, just some of which are discussed herein.

In another embodiment, the second user may be an employee of the first user that makes purchases for items of the first user. For example, the second user may be a contractor working on the home of the first user, and may make purchases associated with working on that home. While the techniques discussed above may be used to determine when such a contractor/second user makes purchases for an item/home owned by the first user, such a relationship opens up other techniques for determining when purchases by the contractor/second user are for an item owned by the first user. For example, the contractor/second user may designate the first user or an item of the first user (e.g., their home) as something the contractor/second user will be making purchases for, may designate one or more merchants (e.g., home improvement merchants) from which purchases made by the contractor/second user will be for the first user, may designate a time period in which purchases made by the contractor/second user will be for the first user, may designate a payment account from which purchases made by the contractor/second user will be for the first user, etc. In some embodiments, the first user may confirm any of the designations provided by the contractor/second user discussed above. As such, particularly relationships between the first user and the second user (e.g., contractor for a home, babysitter for a child, pet-sitter, home-watcher, etc.) may assume some set of purchases by the second user for items owned by the first user, and may exchange specific information about those potential purchases such that they may be detected by the system provider device.

The method 100 then proceeds to block 106 where a favor level of the purchase by the second user for the item owned by the first user is determined. In an embodiment, the system provider device 202 may retrieve a plurality of information from a variety of sources to determine whether the purchase by the second user for the item owned by the first user is a favor performed by the second user for the first user and, if so, determine a “level” or ranking of that favor. In some embodiments, the determination that the second user made a purchase for the item owned by the first user at block 104 may provide for the determination that the second user has performed a favor for the first user. However, in some embodiments, other information may be retrieved that confirms or refutes that the purchase by the second user for the first item is a favor. In the event the purchase by the second user for the item owned by the first user is determined to be a favor, the system provider device 202 may attempt to quantify, rank, or otherwise determine a favor level for that favor. While a few examples of information that may be analyzed to determine a favor level for a favor are provided below, one of skill in the art in possession of the present disclosure will recognize that a variety of factors may be used to determine a ranking or quantification of a favor and will fall within the scope of the present disclosure.

In some embodiments, the system provider device 202 may determine whether the first user device 208 of the first user and the second user device 210 of the second user are regularly co-located or have some co-location history in order to determine whether there is a relationship between the first user and the second user. The determination of a relationship between the first user and the second user may be used to confirm that a purchase made by the second user for an item owned by the first user is a favor, and the communication by co-located user devices 208 and 210 between each other and/or the system provider device 202 may be used to provide an indication of that relationship. Such a relationship “device history” may be further confirmed by retrieving information from the first user device 208 and the second user device 210 such as contact information that indicates the first user and the second user are contacts of each other, social media profile information that indicates that the first user and second user are connected via a social media website, communication information that indicates that the first user and the second user email, text, or call each other at some frequency, etc. For example, attending events at the same time (or in adjacent seats), being “tagged” (i.e., identified) in the same photos on a social media site, splitting a tab at a restaurant, and/or any other information that indicates a link between the users may be used by the system provider device 202 at block 106 to determine whether a favor has been performed. As such, the system provider device may use such techniques to determine that the second user is a “friend” of the first user and thus the purchase made by the second user at block 104 was a favor.

In an embodiment, the second user may report (e.g., via their second user device 210) that the purchase for the item owned by the first user is a favor, and/or may report a favor level for that purchase to the system provider device 202. For example, upon making a purchase for an item owned by the first user, the second user may designate that purchase (e.g., via a payment application being used to make the purchase, on a website being used to make the purchase, etc.) as a purchase being made as a favor to the first user. For example, FIG. 3b illustrates an embodiment of the user device 300 (in this case, a second user device) displaying a favor reporting screen 312 that includes a payment confirmation section 314 that includes details of a payment made by the second user (e.g., the payment account used, the date of the purchase, the item that was purchased, the amount of the purchase, and the item for which the purchase was made). As discussed herein, the item for which the purchase was made that is identified in the payment confirmation section 314 may be detected via communication between a merchant device and the item, reported by the second user, and/or identified in a variety of manners known in the art. The favor reporting screen 312 also includes a favor confirmation section 316 that informs the second user that the purchase has been detected as possibly being a favor (e.g., via the determination of the item for which the purchase was made (i.e., the automobile) and/or other techniques described herein), along with a yes button 318 that the second user may select to confirm that the favor was performed for the first user (i.e., the owner of the automobile) and a no button 320 that the second user may select to inform the system provider device 202 that the purchase was not a favor performed for the first user. In other embodiments, additional screens may be provided that allow the second user to provide corrected information about the user for whom the favor was performed and/or provide any other information needed by the system provider device 202.

In some embodiments, the first user may provide the second user with a code that identifies the first user, and the second user may provide that code when making a purchase for an item owned by the first user in order to indicate that that purchase is a favor for the first user. In some embodiments, the favor reporting screen 312 may provide the second user the ability to rate, rank, or provide a note that indicates the favor level of the favor (e.g., a note that says “your car was out of gas and you have a plane flight early tomorrow, so I filled up your gas tank”). As such, the second user may self-report any details about the favor they have performed for the first user, and may rank or indicate the favor level of that favor themselves.

In an embodiment, the system provider device 202 may determine a favor level of the favor performed by the second user for the first user by using information from a calendar of the first user that is retrieved from the first user device 208 over the network 206. For example, the system provider device 202 may use the information retrieved from the calendar of the first user to estimate a user activity level for the first user during and around the time at which the purchase was made by the second user. This allows the system provider device 202 to determine whether the first user was relatively busy during or around the time in which the purchase was made by the second user by determining whether the first user had one or more activities or appointments scheduled during or around that time. If the first user is determined to have a user activity level that was relatively high, the favor level may be determined to be relatively high or weighted relative to a favor level that may be determined if the first user had a user activity level that was relatively low. Similarly, the system provider device 202 may use information retrieved from the calendar of the second user to estimate a user activity level for the second user during and around the time at which the purchase was made by the second user. This allows the system provider device 202 to determine whether the second user was relatively busy during or around the time in which the purchase was made by the second user by determining whether the second user had one or more activities or appointments scheduled during or around that time. If the second user is determined to have a user activity level that was relatively high, the favor level may be determined to be relatively high or weighted relative to a favor level that may be determined if the second user had a user activity level that was relatively low. One of skill in the art in possession of the present disclosure will recognize how the user activity levels of the first user and/or the second user may allow a determination of how busy those users were when the favor was performed, and thus may be used to determine the level of the favor that was performed.

In an embodiment, the system provider device 202 may determine a favor level of the favor performed by the second user for the first user by using information from a payment account of the first user that is retrieved from the database 204. For example, the system provider device 202 may use payment account information retrieved from a payment account of the first user to determine a balance of the payment account for the first user during and around the time at which the purchase was made by the second user. This allows the system provider device 202 to determine whether the payment account of first user included a relatively low balance during or around the time in which the purchase was made by the second user by, for example, determining whether the balance of the payment account of the first user was below a predetermined level. If the payment account of the first user is determined to have a balance that was relatively low, the favor level may be determined to be relatively high or weighted relative to a favor level that may be determined if the balance of the payment account of the first user was relatively high. Similarly, the system provider device 202 may use payment account information retrieved from a payment account of the second user to determine a balance of the payment account for the second user during and around the time at which the purchase was made by the second user. This allows the system provider device 202 to determine whether the payment account of second user included a relatively low balance during or around the time in which the purchase was made by the second user by, for example, determining whether the balance of the payment account of the second user was below a predetermined level. If the payment account of the second user is determined to have a balance that was relatively low, the favor level may be determined to be relatively high or weighted relative to a favor level that may be determined if the balance of the payment account of the second user was relatively high. One of skill in the art in possession of the present disclosure will recognize how the payment account balances of the first user and/or the second user may allow a determination of the financial situations of those users when the favor was performed, and thus may be used to determine the level of the favor that was performed.

In an embodiment, the system provider device 202 may determine a favor level of the favor performed by the second user for the first user by using location information from the first user device 208 of the first user that is retrieved during or around the time the purchase was made by the second user. For example, the system provider device 202 may use location information retrieved from the first user device 208 of the first user to determine the location of the first user during and around the time at which the purchase was made by the second user. This allows the system provider device 202 to determine whether the first user was away from their home location, moving between a number of different locations in a relatively short period of time, or otherwise very busy. If the first user is determined to have been relatively busy, the favor level may be determined to be relatively high or weighted relative to a favor level that may be determined if the first user was relatively not busy. Similarly, the system provider device 202 may use location information retrieved from the second user device 210 of the second user to determine the location of the second user during and around the time at which the purchase was made by the second user. This allows the system provider device 202 to determine whether the second user was away from their home location, moving between a number of different locations in a relatively short period of time, or otherwise very busy. If the second user is determined to have been relatively busy, the favor level may be determined to be relatively high or weighted relative to a favor level that may be determined if the second user was relatively not busy. One of skill in the art in possession of the present disclosure will recognize how the locations of the first user and/or the second user may allow a determination of how busy those users were when the favor was performed, and thus may be used to determine the level of the favor that was performed.

Using the specific embodiment of the contractor/second user introduced above, location information for the contractor/second user may be combined with date/ time information associated with the purchase made by the second user in order to determine the favor level of the favor performed by the contractor/second user for the first. Many purchases made by a contractor/second user for a first user may not typically be considered favors, but some purchases made by a contractor/second user for a first user may go beyond what is typical and extend to the level of a favor or purchase that the first user would otherwise like to repay. For example, location information for the contractor/second user and date/time information for the purchase made by the contractor/second user may indicate that the contractor/second user made a purchase relatively far away from their home location (or traveled around to several different locations before making that purchase), and the date/time information for the purchase may indicate that the second user made that purchase on a weekend, relatively late at night, or relatively early in the morning. As such, the system provider device 202 may determine from such information that the contractor/second user has gone out of their way in making the purchase and, as such, determine a favor level for that purchase that is relatively high or weighted relative to a favor level for typical purchases made by the contractor/second user for the first user.

In an embodiment, the system provider device 202 may determine a favor level of the favor performed by the second user for the first user by using device density information from the first user device 208 of the first user that is retrieved during or around the time the purchase was made by the second user. For example, the system provider device 202 may receive device density information from the first user device 208 of the first user that is retrieved through the communication by the first user device 208 with user devices near the first user device 208. For example, the first user device 208 may be configured to communicate with any other user device in its proximity that is associated with a user that the first user knows, and through these communications the first user device 208 may be able to determine a device density that is indicative of how many known users are near the first user. This device density information may be communicated by the first user device 208 to the system provider device 202 and allows the system provider device 202 to determine whether the first user was at a group event, meeting with a group of people, or otherwise surrounded by other users they know. If the first user is determined to have been surrounded by other users they know, the favor level may be determined to be relatively high or weighted relative to a favor level that may be determined if the first user was not surrounded by many other users they know.

In an embodiment, the system provider device 202 may determine a favor level of the favor performed by the second user for the first user by determining the amount of the purchase made by the second user for the purchase made for the item owned by the first user. For example, the system provider device 202 may review the purchase information for the purchase made by the second user to determine an amount of that purchase, and determine the favor level based on that amount. In addition, comparison of that amount to the payment account balance of the second user may be used to indicate the favor level of the favor (i.e., the less in the payment account of the second user and the more the purchase amount, the higher the favor level). Similarly, financial liabilities incurred by the second user on or around the time the favor was performed may be considered when determining the favor level. For example, if the second user received a speeding ticket, was in a car accident, missed an event (e.g., a movie), and/or otherwise suffered some detriment in association with performing the favor for the first user, that may be considered when determining the favor level of the favor (i.e., the bigger the detriment experience by the second user in performing the favor, the higher the favor level).

As such, favor levels may be determined for purchases made by second users that are associated with items owned by first user by determining that the first user was relatively busy when that purchase was made, was low on funds in their payment account, or was experiencing a situation that otherwise made it difficult for the first user to make that purchase themselves. As discussed below, the favor level determined for the purchase made by the second user may be used to determine favor repayment options to present to the first user for repaying the favor to the second user. However, in some embodiments, the determination of the favor level may simply be used to determine the likelihood that the purchase by the second user was a favor or not, and if that purchase is determined to be likely to be a favor, favor repayment options may be determined and presented to the first user without using that favor level to also determine which of a plurality of possible favor repayment options to present to the first user.

The method 100 then proceeds to block 108 where first user favor repayment settings are retrieved. In an embodiment, the user may have provided one or more favor repayment settings to the system provider device 202 (e.g., prior to the performance of the method 100) that were then stored in the database 204, and at block 108 the system provider device 202 may retrieve those favor repayment settings from the database 204. For example, the first user may provider favor repayment settings that instruct the system provider device 202 to automatically reimburse any purchases that are below a predetermined amount (e.g., $10), select an item from a second user favor repayment list (discussed below) for any purchases in a predetermined price range (e.g., between $10 and $50), and request authorization from the first user to reimburse the second user for any purchases above a predetermined amount (e.g., above $50). In another example, the first user may provide one or more second users to which favors should be repaid in the favor repayment settings, and thus second users not designated in the favor repayment settings would not have favors repaid or purchases reimbursed by the first user using the favor detection and repayment system 200.

Furthermore, the first user may designate favor levels, discussed above with reference to block 106, that may be used by the system provider device 202 to determine how a favor should be repaid. For example, the first user may provide favor repayment settings that instruct the system provider device 202 to reimburse the second user and purchase an item for the second user off a second user favor repayment list (discussed below) if the first and/or second user were relatively busy (e.g., was determined to have a relatively high user activity level) when the purchase was made by the second user, if the second user had to travel relatively far to make the purchase, if the first and/or second user's payment account had a relatively low balance when the purchase was made by the second user, and/or based on other information that indicates that the purchase inconveniences the second user and/or particularly beneficial to the first user. While a few examples have been provided, one of skill in the art in possession of the present disclosure will recognize that the first user may designate any of a variety of favor repayment settings that may be used by the system provider device 202 to determine how the favor should be repaid while remaining within the scope of the present disclosure. Furthermore, in some embodiments, block 108 may be skipped (e.g., when the purchase made or favor performed by the second user is not subject to favor repayment settings provided by the first user, or in embodiments where the first user has not provided favor repayment settings).

In some embodiments, the first user favor repayment settings may aggregate smaller favors (e.g., favors including purchases under $5) performed by a second user until those smaller favors include a number of purchases that exceeds an aggregated amount (e.g., $25). As such, the system provider device 202 may detect and store favors by the second user that are below a predetermined amount until those favors reach the aggregated amount, at which time the system provider device may retrieve a second user favor repayment list (discussed below) and inform the first user of the aggregated favors and favor repayment options (also discussed below).

The method 100 then proceeds to block 110 where a second user favor repayment list may be retrieved. In some embodiments, the second user may provide, or perform actions that provide, a favor repayment list that the system provider device 202 stores in the database 204 (e.g., prior to the method 100) and then retrieves the list at block 110. For example, the second user may provide an item list (sometimes referred to as a “wish list” or “gift list”) that includes items that the second user would like to be considered when others are repaying favors that the second user has performed. As such, the favor repayment list of the second user may include items explicitly selected by the second user. In another example, the favor repayment list of the second user may be may be determined by the system provider device 202 detecting that the second user has previously viewed items (e.g., on an Internet browser, via a payment application, etc.) some number of times such that interest in those items can be implied. As such, the favor repayment list of the second user may include items implicitly selected by the second user.

Purchase histories of the second user may be used by the system provider device to determine whether a previously viewed item is appropriate to add to a favor repayment list of the second user, as well as used to determine items that the second user may need. For example, a purchase history may be used to determine that a user has not recently purchased shoes, and a browser history may indicate that the user has recently viewed shoes for purchase, which may cause the system provider device to add the shoes that were viewed to the favor repayment list for the second user. In some embodiments, implicitly selected items on the favor repayment list may be presented to the second user for confirmation, modification, and/or detail requests (e.g., size, color, or other details of clothing items).

The method 100 then proceeds to block 112 where the first user is informed of the favor and provided favor repayment options. In an embodiment, the system provider device 202 may use all the information determined and retrieved above including, for example, the information about the purchase the second user made for the item owned by the first user, the favor level determined for the purchase by the second user, the favor repayment settings of the first user, and the favor repayment list of the second user, in order to determine favor repayment options for repaying the favor performed by the second user. The system provider device 202 may then inform the first user of the favor (e.g., via their user device 208) and provide those favor repayment options for display on the first user device 208. While a few examples are illustrated and provided below, one of skill in the art in possession of the present disclosure will recognize that the first user may be informed of the favor and the favor repayment options may be presented to the first user in a variety of manners that will fall within the scope of the present disclosure.

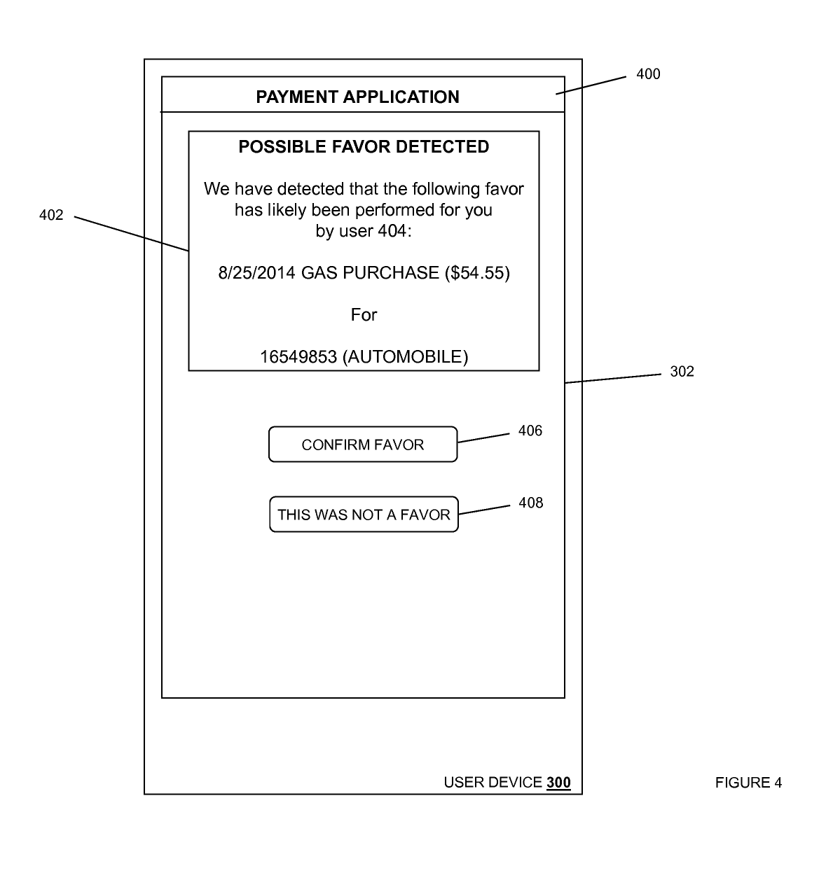

Referring now to FIG. 4, an embodiment of the user device 300 displaying a favor detection screen 400 is illustrated. In some embodiments, the favor detection screen 400 may be provided on the user device 300 any time a favor is detected and/or according to favor repayment settings provided by the first user. In some embodiments, the favor detection screen 400 may not be provided on the user device 300 of a first user (e.g., when favor repayment settings provided by the first user instruct the system provider device 202 to automatically reimburse a detected favor).

The favor detection screen 400 includes favor detection information 402 that informs the first user that a favor has possibly been performed for them, along with information about the second user that performed the possible favor (e.g., identifying the user 404), details about the purchase made by the second user (e.g., a gas purchase for $54.55 on Aug. 25, 2014) that is associated with an item owned by the first user (e.g., an automobile associated with an identifier 16549853). While a specific example is provided, other information may be provided on the favor detection screen 400 about a favor that has been detected by the system provider device 202, including the merchant at which the purchase was made, a history of favors that the second user (e.g., user 404) has performed for the first user, favor level information such as the user activity level of the first and/or second user or the payment account balance of the first and/or second user when the purchase was made by the second user, and/or any other information retrieved or determined by the system provider device 202 in performing the method 100. The favor detection screen 400 also includes a favor confirmation button 406 that the first user may select to confirm that the possible favor detected by the system provider device 202 is actually a favor, and a favor deny button 408 that the first user may select to deny that the possible favor detected by the system provider device 202 is a favor.

Thus, upon detection of a possible favor performed for the first user, the first user may be informed of that possible favor, and may be given the opportunity to confirm that the possible favor is actually a favor, or deny that the possible favor is a favor. In some embodiments, the method 100 may end following the informing of the first user of the favor, which simply allows the first user to be informed of favors that are performed for them. In some embodiments, confirmed favors may then be saved in the database 204 by the system provider device 202 and information about those confirmed favors (e.g., second user information, purchase amounts, etc.) may be accessible by the first user through their first user device to review users that have performed them favors. In some embodiments, the first user device 208 may be configured to detect when the second user device 210 that is associated with a second user that has performed a favor for the first user is proximate to the first user device 208 (e.g., via communication between the user devices and/or with the system provider device 202) and, in response, may provide an alert to the first user (through the first user device 208) that reminds the user that that second user previously performed a favor for the first user.

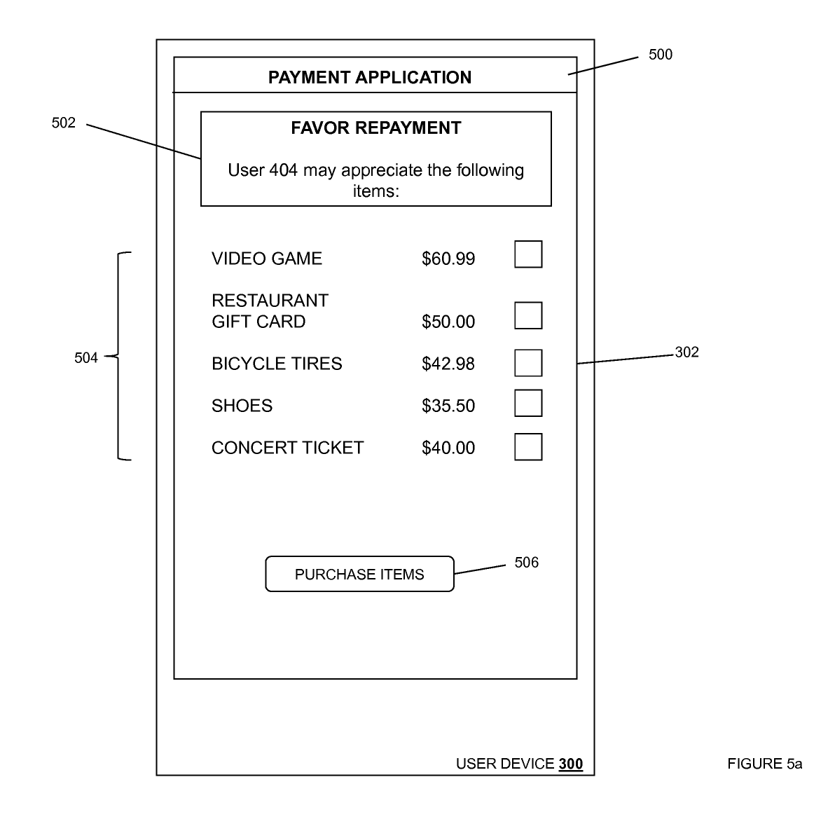

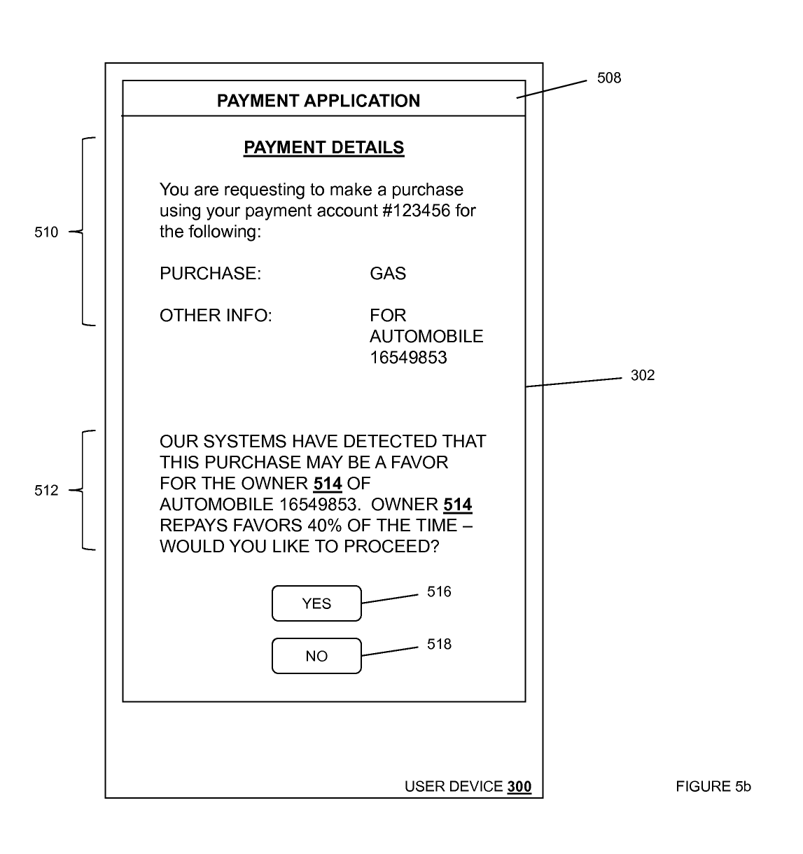

Referring now to FIG. 5a, an embodiment of the user device 300 displaying a favor repayment screen 500 is illustrated. In some embodiments, the favor repayment screen 500 may be provided on the user device 300 following the detection of a favor and/or following the first user confirming a favor (e.g., as discussed above with reference to FIG. 4). In some embodiments, the favor repayment screen 500 may not be provided on the user device 300 of a first user (e.g., when favor repayment settings provided by the first user instruct the system provider device 202 to automatically reimburse a detected favor).

The favor repayment screen 500 includes a favor repayment message 502 that informs the first user that a favor repayment list has been retrieved for the second user, and a plurality of favor repayment items 504 that were included in the favor repayment list. Each of the favor repayment items may include a description of the favor repayment item, a price of the favor repayment item, and a selector that the first user may select to indicate a desire to purchase that favor repayment item for the second user. Upon selecting the selector(s) for the favor repayment items that they would like to purchase for the second user, the first user may select a purchase items button 506 on the favor repayment screen 500 in order to pay for the selected favor repayment items. In some embodiments, the selection of the purchase items button 506 may be followed with one or more purchasing screens that allow the first user to provider payment account details, shipping information, and/or other purchasing information known in the art. However, the first user may have previously provided their purchasing account details, and the second user may have previously provided their shipping details (e.g., via the favor repayment list) such that that information does not need to be input by the first user. As such, following the selection of the purchase items button 506, the purchase of the favor repayment items for the second user by the first user may be completed such that the favor repayment items are sent to the second user, and in some cases the first user may be allowed to provide a message to the second user (e.g., a “thank you” message).

In some embodiments, there may be no items on the favor repayment list of the second user that are commensurate with the purchase made by the second user for the item owned by the first user. In such embodiments, the details of the favor/purchase may be saved, and aggregated with one or more subsequent purchases until the aggregated amount of the favors/purchases are commensurate with the items on the favor repayment list of the second user. As such, items presented to the user in the plurality of favor repayment items 504 may be filtered by costs using the amount of the purchase made by the second user such that only items commensurate with the amount of the purchase by the second user are presented to the first user as favor repayment options.

The method 100 performed by the favor detection and repayment system 200 may be used to collect favor performance and repayment data about the first user and the second user and associate that data with each of those users. This may allow the system provider device 202 to report metrics for each of the first users and second users in the system. For example, the system provider device 202 may track details about how the first user repays favors performed for them, and report that information to second users. As such, second users may be informed of how likely a first user is to repay a favor that is performed for them. For example, FIG. 5b illustrates an embodiment of the user device 300 (a second user device in this embodiment) displaying a favor information reporting screen 508 that includes a payment details section 510 that includes details of a payment to be made by the second user (e.g., information about a payment account to be used for the payment, a purchase type, and an item for which the purchase will be made). The favor information reporting screen 508 also includes a favor confirmation section 512 that reports favor data about the first user to the second user (e.g., that the payment has been detected as a possible favor for the first user (user 514 in this embodiment), and how often the first user has been detected repaying such favors. The favor information reporting screen 508 also includes a yes button 516 that the second user may select to confirm they would like to proceed with the payment/favor, and a no button 518 to cancel making the payment using their payment account.

Similarly, the system provider device 202 may track details about favors performed by a second user for one or more first users. As such, first users may be informed how often the second user performs favors for them and/or for other users, which may be used to determine the level of repayment of a favor by a first user (e.g., the first user may be informed that the second user performs favors often for them and other users, and possibly that the second user is not repaid for those favors half the time, and thus the first user may determine that the repayment of the favor should include an item that exceeds the amount of the purchase the second user made for the item owned by the first user). Combinations of this favor detection and repayment data may be used by the system provider device 202 and/or presented to first users and/or second users to glean a variety of information such as, for example, how often favors are performed for a particular first user, how often favors performed by a second user a repaid, the typical level of repayment of favors by first users, the typical level of repayment to a second user for favors performed, etc.

Thus, systems and methods for favor detection and repayment operate to detect when favors are performed for a user, and inform that user of the favor that was performed for them. In specific embodiments, the favors detected are purchases made by second users for items owned by a first user, and the favor performed may be quantified based on information retrieved from the first user and the second user that indicates how busy those users were, a financial state of those users, and/or other information that is indicative of how the purchase (and thus the favor) may have affected each of the first user and the second user. Favor repayment options for repaying the favor by the first user may then be determined and provided to the first user to assist the first user in repaying the second user for the favor performed. As such, users may be more quickly and easily informed of favors performed for them, and provided the ability to repay such favors quickly and easily and with items or other return favors that are most desired by the second user.

The systems and methods discussed above with enable a variety of favor and favor repayment scenarios to be realized by the first users and second users discussed above. A few examples of specific scenarios are provided below, but those examples should not be interpreted to be limiting, as any of a wide variety of favors and favor repayment situations are envisioned as falling within the scope of the present disclosure.

In a first example, a first user and a second user are friends, and the first user is getting married. The system may determine that the first user and the second user are friends based on previous time those users have spent together (e.g., co-location of their user devices), their purchasing of event tickets for the same events, having been tagged in the same photos on social media sites, having split checks at restaurants, etc. Furthermore, the system may determine that the first user is the owner of a car based on a purchase of that car by the first user, lease payment for that car by the first user, purchases made by the first user for that car (e.g., gas, service, etc.). On the weekend of the wedding for the first user, the system will determine that the first user is very busy based on a review of the first user's calendar, tracking of the first user device of the first user, reviewing a device density around the first user device of the first user, etc. Furthermore, the system may determine that a payment account of the first user has been used to make multiple payments for the wedding recently, and has a lower balance than is normal. At some point during the wedding weekend, the second user may borrow the first user's car and, while using that car, fill the car up with gas. The system may detect that the second user has made a purchase of gas for the car of the first user using any of the techniques discussed above. Based on the determinations that the first user and second user are friends, the first user owns the car, and the first user is very busy and has limited funds, the system determines that the second user has performed a favor for the first user, and reports that favor to the first user. Upon receiving the report (or reviewing that report sometime following the wedding), the first user may request or otherwise be provided favor repayment options that include one or more items that the first user may purchase for the second user in order to repay the favor.

In a second example, the first user may hire the second user to perform work on the first user's home. The system may determine that the first user and the second user are associated based on reporting from the first user and/or the second user that they have entered into the business relationship, review of a contract for the business relationship that is accessible by the system, etc. Furthermore, the system may determine that the first user is the owner of (or otherwise responsible for) the home based on a purchase of that home by the first user, rent payments for that home by the first user, purchases made by the first user for that home (e.g., gardening services, previous repairs, utility bills, etc.). The system may determine an agreed-upon date (e.g., from the contract) that the work should be completed by, but may also review the calendar of the first user to determine that it would be much more convenient for the work to be completed earlier (e.g., based upon a scheduled trip for the first user). The system may then detect that the second user has gone out of their way to make purchases of materials (e.g., at locations relatively far away from their home location, on weekends, at inconvenient times), has worked late and/or on weekends, and/or has otherwise performed actions to complete the work earlier than was agreed upon. Based on the determinations that the first user and second user are associated via the work contract, the first user is responsible for the home, and that early completion of the work would be of great convenience for the first user, the system determines that the second user has performed a favor for the first user, and reports that favor to the first user. Upon receiving the report, the first user may decide to pay the second user a bonus for the extra effort performed in exceeding the terms of the contract, and/or may request or otherwise be provided favor repayment options that include one or more items that the first user may purchase for the second user in order to repay the favor. In some embodiments, the information collected by the system may be used to update the first user on the actions of the second user in performing the work (e.g., updates on when materials are purchased, when work was done, whether work is on track to be completed by an agreed upon date, etc.).

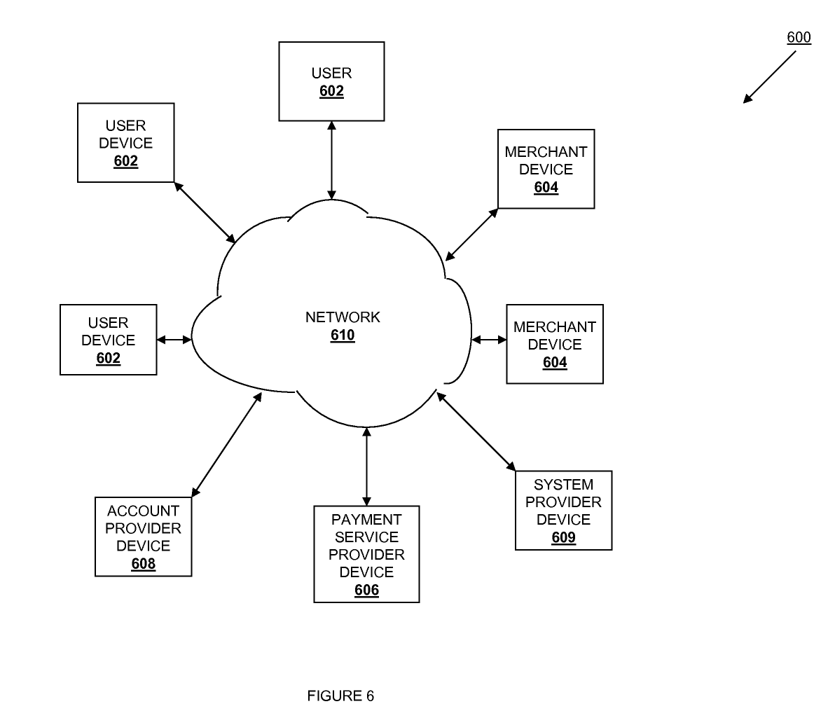

Referring now to FIG. 6, an embodiment of a network-based system 600 for implementing one or more processes described herein is illustrated. As shown, network-based system 600 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 600 illustrated in FIG. 6 includes a plurality of user devices 602, a plurality of merchant devices 604, a payment service provider device 606, an account holder device 608, and a system provider device 609 in communication over a network 610. Any of the user devices 602 may be the user devices discussed above and may be operated by the user discussed above. The merchant devices 604 may be the merchant devices discussed above and may be operated by the merchants discussed above. The payment service provider device 606 may be the payment service provider devices discussed above and may be operated by a payment service provider such as, for example, PayPal Inc. of San Jose, Calif. The account provider devices 608 may be the account provider devices discussed above and may be operated by the account providers discussed above such as, for example, credit card account providers, bank account providers, savings account providers, and a variety of other account providers known in the art. The system provider device 604 may be the system provider devices discussed above and may be operated by the system providers discussed above

The user devices 602, merchant devices 604, payment service provider device 606, account provider device 608, and/or system provider device 609 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The user device 602 may be implemented using any appropriate combination of hardware and/or software configured for wired and/or wireless communication over network 610. For example, in one embodiment, the user device 602 may be implemented as a personal computer of a user in communication with the Internet. In other embodiments, the user device 602 may be a smart phone, personal digital assistant (PDA), laptop computer, and/or other types of computing devices.

The user device 602 may include one or more browser applications which may be used, for example, to provide a convenient interface to permit the user to browse information available over the network 610. For example, in one embodiment, the browser application may be implemented as a web browser configured to view information available over the Internet.

The user device 602 may also include one or more toolbar applications which may be used, for example, to provide user-side processing for performing desired tasks in response to operations selected by the user. In one embodiment, the toolbar application may display a user interface in connection with the browser application.

The user device 602 may further include other applications as may be desired in particular embodiments to provide desired features to the user device 602. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 610, or other types of applications. Email and/or text applications may also be included, which allow the payer to send and receive emails and/or text messages through the network 610. The user device 602 includes one or more user and/or device identifiers which may be implemented, for example, as operating system registry entries, cookies associated with the browser application, identifiers associated with hardware of the user device 602, or other appropriate identifiers, such as a phone number. In one embodiment, the user identifier may be used by the payment service provider device 606 and/or account provider device 608 to associate the user with a particular account as further described herein.

The merchant device 604 may be maintained, for example, by a conventional or on-line merchant, conventional or digital goods seller, individual seller, and/or application developer offering various products and/or services in exchange for payment to be received conventionally or over the network 610. In this regard, the merchant device 604 may include a database identifying available products and/or services (e.g., collectively referred to as items) which may be made available for viewing and purchase by the user.

The merchant device 604 also includes a checkout application which may be configured to facilitate the purchase by the payer of items. The checkout application may be configured to accept payment information from the user through the user device 602, the account provider through the account provider device 608, and/or from the payment service provider through the payment service provider device 606 over the network 610.

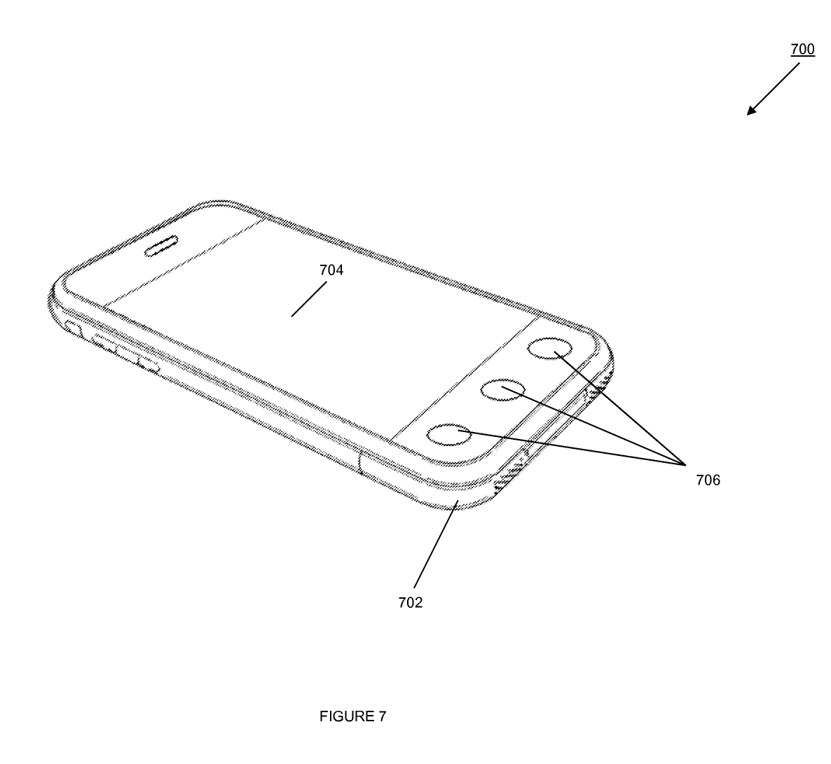

Referring now to FIG. 7, an embodiment of a user device 700 is illustrated. The user device 700 may be the user devices discussed above and may be operated by the users discussed above. The user device 700 includes a chassis 702 having a display 704 and an input device including the display 704 and a plurality of input buttons 706. One of skill in the art will recognize that the user device 700 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

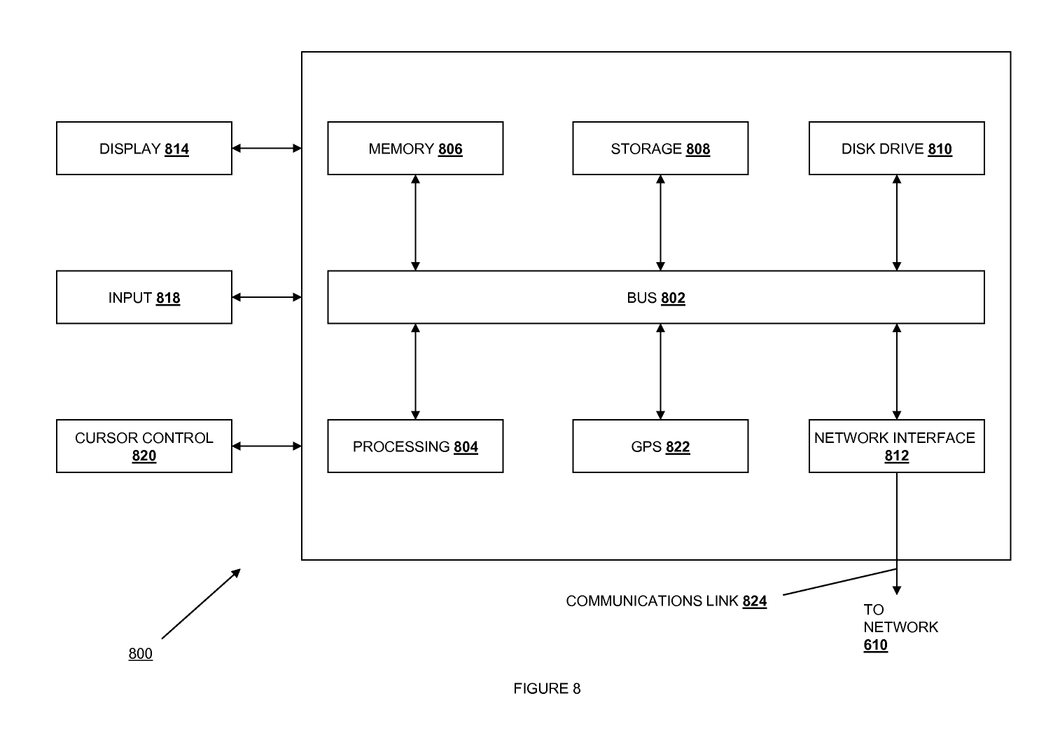

Referring now to FIG. 8, an embodiment of a computer system 800 suitable for implementing, for example, the user devices 602, merchant devices 604, payment service provider device 606, account provider device 608, and/or system provider device 609, is illustrated. It should be appreciated that other devices utilized by payer, payees, payment service providers, and account providers in the payment system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the user devices 602, merchant devices 604, payment service provider device 606, account provider device 608, and/or system provider device 609. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

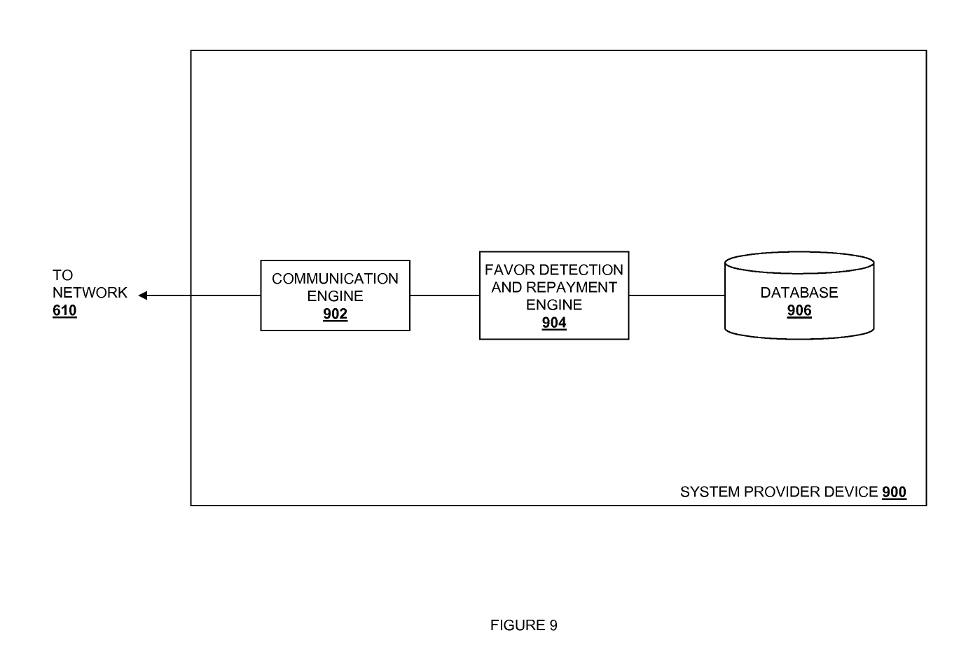

Referring now to FIGS. 9, an embodiment of a system provider device 900 is illustrated. In an embodiment, the device 900 may be the system provider devices discussed above. The device 900 includes a communication engine 902 that is coupled to the network 610 and to favor detection and repayment engine 904 that is coupled to a database 906. The communication engine 902 may be software or instructions stored on a computer-readable medium that allows the device 900 to send and receive information over the network 610. The favor detection and repayment engine 904 may be software or instructions stored on a computer-readable medium that is configured to create ownership associations between users and items, store the ownership associations in the database 906, determine a user has made a purchase for an item owned by another user, determine a favor level of the purchase, retrieve favor repayment settings, retrieve favor repayment lists, information users of favors that have been performed for them, provide favor repayment options, and provide any of the other functionality that is discussed above. While the database 906 has been illustrated as a single database located in the payer device 900, one of skill in the art will recognize that it may include multiple databases and/or be connected to the favor detection and repayment engine 904 through the network 610 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A favor detection and repayment system, comprising:
a non-transitory memory storing an ownership association between a first user and a first user item;
one or more hardware processors coupled to the memory and configured to read instructions from the memory to perform the steps of:
detecting that a second user has made a purchase that is associated with the first user item;
determining that the purchase by the second user that is associated with the first user item is a favor for the first user by the second user;
retrieving favor repayment information;
providing a favor detection message for display to the first user; and
providing at least one favor repayment option for display to the first user using the favor repayment information.

2. The system of claim 1, wherein the one or more hardware processors are configured to read instructions from the memory to perform the steps of:
determining that the first user is the owner of the first user item and, in response, creating the ownership association between the first user and the first user item and storing the ownership association in the non-transitory memory.

3. The system of claim 2, wherein the determining that the first user is the owner of the first user item includes receiving an ownership designation for the first user item from a first user device that is associated with the first user.

4. The system of claim 1, wherein the detecting that the second user has made a purchase that is associated with the first user item includes receiving purchase information that is associated with the purchase and that identifies the second user and the first user item.

5. The system of claim 1, wherein the determining that the purchase by the second user is the favor for the first user includes retrieving a first user calendar associated with the first user, and determining a first user activity level for the first user when the purchase was made using the first user calendar.

6. The system of claim 1, wherein the favor repayment information includes a list of items that have been selected by the second user.

7. A method for favor detection and repayment, comprising:
storing, by a system provider device in a database, an ownership association between a first user and a first user item;
detecting, by the system provider device through a purchase communication that is received over a network, that a second user has made a first purchase that is associated with the first user item;
determining, by the system provider device, that the first purchase by the second user that is associated with the first user item is a favor for the first user by the second user;
retrieving, by the system provider device from the database, favor repayment information;
providing, by the system provider device, a favor detection message for display on a first user device that is associated with the first user; and
determining, by the system provider device, at least one favor repayment option using the favor repayment information and providing the at least one favor repayment option for display on the first user device that is associated with the first user.

8. The method of claim 7, further comprising:
determining, by the system provider device, the ownership association between the first user and the first user item using purchase information for the first user item in a first user payment account that is associated with the first user.

9. The method of claim 8, further comprising:
confirming, by the system provider device, the ownership association between the first user and the first user item based on at least one second purchase that was made by the first user and that is associated with the first user item.

10. The method of claim 7, wherein the detecting that the second user has made the first purchase that is associated with the first user item includes determining that a second user device that is associated with the second user was co-located with the first user item when the first purchase was made.

11. The method of claim 7, wherein the determining that the first purchase by the second user is the favor for the first user includes retrieving first user payment account information associated with the first user, and determining that the first user payment account information indicates that the first user payment account of the first user has a balance that is lower than a predetermined amount.

12. The method of claim 7, wherein the favor repayment information includes at least one favor repayment setting that was provided by the first user.

13. The method of claim 7, further comprising:
receiving, by the system provider device from the first user device, a selection of the at least one favor repayment option and, in response, automatically making a purchase of an item that is associated with the favor repayment option using a first user payment account that is associated with the first user.

14. A non-transitory computer-readable medium comprising instructions which, in response to execution by a computer system, cause the computer system to perform a method comprising:
storing an ownership association between a first user and a first user item;
detecting that a second user has made a purchase that is associated with the first user item;
determining that the purchase by the second user that is associated with the first user item is a favor for the first user by the second user;
retrieving favor repayment information;
providing a favor detection message for display to the first user; and
providing at least one favor repayment option for display to the first user using the favor repayment information.

15. The non-transitory machine-readable medium of claim 14, wherein the method further comprises:
determining the ownership association between the first user and the first user item based on a first user device that is associated with the first user being co-located with the first user item a predetermined number of times.

16. The non-transitory machine-readable medium of claim 14, wherein the method further comprises:
determining the ownership association between the first user and the first user item based on an ownership designation received from a first user device associated with the first user.

17. The non-transitory machine-readable medium of claim 14, wherein the detecting that the second user has made the first purchase that is associated with the first user item includes receiving purchase information about the purchase from the first user item.

18. The non-transitory machine-readable medium of claim 14, wherein the detecting that the second user has made the first purchase that is associated with the first user item includes determining that a second user device that is associated with the second user was co-located with the first user item when the first purchase was made.

19. The non-transitory machine-readable medium of claim 14, wherein the determining that the purchase by the second user is the favor for the first user includes retrieving a first user calendar associated with the first user, and determining a first user activity level for the first user when the purchase was made using the first user calendar.

20. The non-transitory machine-readable medium of claim 14, wherein the favor repayment information includes a list of items that have been previously viewed by the second user on a second user device.
